(19) United States
(12) Patent Application Publication
(10) Pub. No.: US 2026/0352660 A1
(43) Pub. Date: Nov. 5, 2026

(54) DEVICE DISCOVERY METHOD AND ELECTRONIC DEVICE

(71) Applicant: Shenzhen Oceanwing Smart Innovations Technology Co., Ltd, SHENZHEN (CN)

(72) Inventor: Jiacai PENG, SHENZHEN (CN)

(73) Assignee: Shenzhen Oceanwing Smart Innovations Technology Co., Ltd, SHENZHEN (CN)

(21) Appl. No.: 19/714,410

(22) Filed: Jun. 20, 2026

Related U.S. Application Data
(63) Continuation of application No. PCT/CN2024/126158, filed on Oct. 21, 2024.

(30) Foreign Application Priority Data
Dec. 21, 2023 (CN) 202311781886.3

(51) Int. Cl. H04L 9/40

(52) U.S. Cl. CPC H04L 63/0876

(57) ABSTRACT

A device discovery method and an electronic device are disclosed. The device discovery method includes: receiving an ARP announcement packet sent by a security sending device, the ARP announcement packet includes a sender protocol address field and a padding field configured for verification; extracting verification information from the padding field to perform verification processing on the ARP announcement packet to obtain a verification result; extracting an information receiving port of the security sending device from the padding field in response to the verification result being successful; and connecting to a sender protocol address contained in the sender protocol address field and the information receiving port, and sending device information of the security receiving device to the information receiving port of the security sending device to complete device discovery.

### CROSS REFERENCE TO RELATED APPLICATIONS

The present application is a continuation of International Patent Application No. PCT/CN2024/126158, filed on Oct. 21, 2024, which claims priority to Chinese Patent Application No. 202311781886.3, filed on Dec. 21, 2023 with the China National Intellectual Property Administration, the entire contents of which are incorporated herein by reference.

### TECHNICAL FIELD

The present disclosure relates to the technical field of the Internet of Things (IoT), and in particular to a device discovery method and an electronic device.

### BACKGROUND

With the development of the Internet of Things (IoT), mutual discovery and connection are prerequisites for communication and data processing between devices in a local area network.

However, in a user's complex network environment, some discovery solutions may fail to forward or receive data packets, resulting in failure to discover devices.

### SUMMARY

The present disclosure may at least provide a device discovery method and an electronic device.

In a first aspect, the present disclosure may provide a device discovery method applied to a security receiving device. The method may include: receiving an ARP announcement packet sent by a security sending device, the ARP announcement packet includes a sender protocol address field and a padding field configured for verification; extracting verification information from the padding field to perform verification processing on the ARP announcement packet and obtain a verification result; extracting an information receiving port of the security sending device from the padding field in response to the verification result being successful; and connecting to a sender protocol address contained in the sender protocol address field and the information receiving port, and sending device information of the security receiving device to the information receiving port of the security sending device to complete device discovery.

In some embodiments, the extracting the verification information from the padding field to perform the verification processing on the ARP announcement packet and obtain the verification result, may include: extracting a random value and a target verification value from the padding field, and extracting the sender protocol address from the sender protocol address field; obtaining a verification value based on the sender protocol address, the random value, and a pre-shared salt value by using a preset algorithm; and comparing the verification value with the target verification value to obtain the verification result, the verification result may be indicated to be successful in response to the verification value being identical to the target verification value.

In some embodiments, the obtaining the verification value based on the sender protocol address, the random value, and the pre-shared salt value by using the preset algorithm, may include the following condition:

the verification value=CRC32(IP+Salt+Random value)
where the CRC32 may represent the preset algorithm, the IP may represent the sender protocol address, the Salt may represent the pre-shared salt value, and the Random value may represent the random value, “+” may denote concatenation of byte sequences.

In some embodiments, the receiving the ARP announcement packet sent by the security sending device, may include: receiving the ARP announcement packet by using a first preset function.

In some embodiments, the connecting to the sender protocol address contained in the sender protocol address field and the information receiving port, may include: establishing a TCP connection to the sender protocol address and the information receiving port.

In a second aspect, the present disclosure may provide a device discovery method applied to a security sending device. The method may include: generating and sending an ARP announcement packet to a security receiving device, the ARP announcement packet may include a sender protocol address field and a padding field; the padding field carries a random value, a target verification value, and an information receiving port of the security sending device; the padding field is configured to enable a security receiving device to perform verification processing on the ARP announcement packet and to extract the information receiving port upon successful verification; and receiving device information sent by the security receiving device through the information receiving port to complete device discovery.

In some embodiments, the generating the ARP announcement packet, may include: obtaining the target verification value based on a sender protocol address in the sender protocol address field, the random value, and a pre-shared salt value by using a preset algorithm; padding the random value and the target verification value into the padding field configured for verification; and generating the ARP announcement packet based on the sender protocol address field and the padding field.

In some embodiments, the obtaining the target verification value based on the sender protocol address in the sender protocol address field, the random value, and the pre-shared salt value by using the preset algorithm, may include:

the target verification value=CRC32(IP+Salt+Random value)
where the CRC32 represents the preset algorithm, the IP may represent the sender protocol address, the Salt may represent the pre-shared salt value, and the Random value may represent the random value, “+” may denote concatenation of byte sequences.

In some embodiments, the device discovery method may further include: sending the ARP announcement packet by using a second preset function.

In some embodiments, the device discovery method may further include: re-sending the ARP announcement packet a predetermined number of times at a first preset time interval in response to no device information sent by the security receiving device being received within a preset time period.

In some embodiments, the device discovery method may further include: sending the ARP announcement packet at a second preset time interval in response to device information sent by the security receiving device being received within the preset time period.

In some embodiments, the device discovery method may further include: re-sending the ARP announcement packet a predetermined number of times at a first preset time interval in response to no device information sent by the security receiving device being received within a preset time period; and sending the ARP announcement packet at a second preset time interval in response to device information sent by the security receiving device being received within the preset time period.

In some embodiments, the padding field may have a length of 18 bytes. The random value may occupy 4 bytes, the target verification value may occupy 4 bytes, and the information receiving port may occupy 2 bytes within the padding field.

In a third aspect, the present disclosure may provide an electronic device. The electronic device may include a memory and a processor coupled to each other. The processor may be configured to execute program instructions stored in the memory to implement the device discovery method in the first aspect and the device discovery method in the second aspect.

It should be understood that both the foregoing general description and the following detailed description are exemplary and explanatory only and are not restrictive of the present disclosure.

### BRIEF DESCRIPTION OF THE DRAWINGS

The accompanying drawings herein are incorporated into and constitute a part of the specification. The accompanying drawings illustrate embodiments consistent with the present disclosure and are used together with the specification to explain the technical aspects of the present disclosure.

FIG. 1 is a schematic flowchart of a device discovery method according to some embodiments of the present disclosure.

FIG. 2 is a schematic structural diagram of an Ethernet frame according to some embodiments of the present disclosure.

FIG. 3 is another schematic flowchart of the device discovery method according to some embodiments of the present disclosure.

FIG. 4 is a schematic structural diagram of an electronic device according to some embodiments of the present disclosure.

FIG. 5 is a schematic structural diagram of a non-volatile computer-readable storage medium according to some embodiments of the present disclosure.

### DETAILED DESCRIPTION

The present disclosure will be described in further detail below with reference to the accompanying drawings and embodiments. It should be particularly noted that the following embodiments are merely used to explain the present disclosure but are not intended to limit the scope of the present disclosure. Similarly, the following embodiments are only some embodiments of the present disclosure rather than all embodiments.

The term “embodiment” mentioned in the present disclosure means that a specific feature, structure, or characteristic described in conjunction with the embodiment may be included in at least one embodiment of the present disclosure. The appearances of the phrase in various places in the specification are not necessarily all referring to the same embodiment, nor are separate or alternative embodiments mutually exclusive of other embodiments. Those skilled in the art may explicitly and implicitly understand that the embodiments described herein may be combined with other embodiments.

The term “and/or” herein is merely an association relationship describing associated objects, indicating that three relationships may exist. For example, A and/or B may indicate the presence of A alone, A and B together, or B alone. In addition, the character “/” herein generally indicates that the associated objects are in an “or” relationship. In addition, “a plurality of” herein means two or more. In addition, the term “at least one type” herein means any one type of multiple types or any combination of at least two types of multiple types. For example, including at least one type of A, B, and C may indicate including any one or more elements selected from a set consisting of A, B, and C. In addition, the terms “first”, “second”, and “third” in the present disclosure are merely used for description purposes and shall not be construed as indicating or implying relative importance or implicitly indicating the quantity of indicated technical features.

As described above, with the development of the Internet of Things (IOT), mutual discovery and connection are prerequisites for communication and data processing between devices in a local area network. However, in a user's complex network environment, some discovery solutions may fail to forward or receive data packets, resulting in failure to discover devices.

Related discovery methods may include a broadcast protocol, a multicast protocol, and an MDNS protocol of Apple Inc. A broadcast may refer to sending data packets to all possible receivers in a network by using broadcast messages. To avoid network storms, a router may not forward broadcasts to sub-routers. Such a discovery method may fail to discover devices connected to sub-routers in a mesh network. A multicast may mean that devices join a multicast address, and the devices in a multicast group may receive device information messages. Routers of different manufacturers may have different settings. Some routers may not forward multicast packets, and some routers may not forward multicast packets after a firewall is enabled, causing devices to be unable to discover each other. The MDNS discovery protocol of Apple Inc. may use DNS plus multicast technology. Most routers may support the MDNS protocol, and the discovery efficiency may be better than that of multicast. However, if a same IoT device supports the Homekit protocol and an additional group of MDNS is used to discover private devices, Homekit authentication of Apple Inc. may fail.

The present disclosure may provide a device discovery method, an electronic device, and a storage medium.

An address resolution protocol (ARP) may be a protocol for implementing mapping from an Internet protocol (IP) address to a media access control (MAC) address, that is, a protocol which may inquire about a MAC address corresponding to a target IP address.

The main way for a link layer to identify an ARP frame may be through an Ethernet type field of the frame. At a header of an Ethernet frame, a 16-bit field may be referred to as a “type” or “EtherType”, which may be configured to indicate a protocol type of payload (that is, a data part of the frame).

For the ARP frame, a value of the type field may be 0x0806. In a case where the link layer receives a frame and the value of the type field is 0x0806, the link layer may determine that the frame is an ARP frame. The link layer may transmit the ARP frame to an ARP processing program of a network layer. The ARP processing program may further parse content of the ARP frame, which may include a source IP address, a target IP address, a source MAC address, and other information.

At the header of the Ethernet frame, a value of the type field for an IP data packet may be 0x0800. Therefore, the link layer may identify an IP data packet by checking the type field.

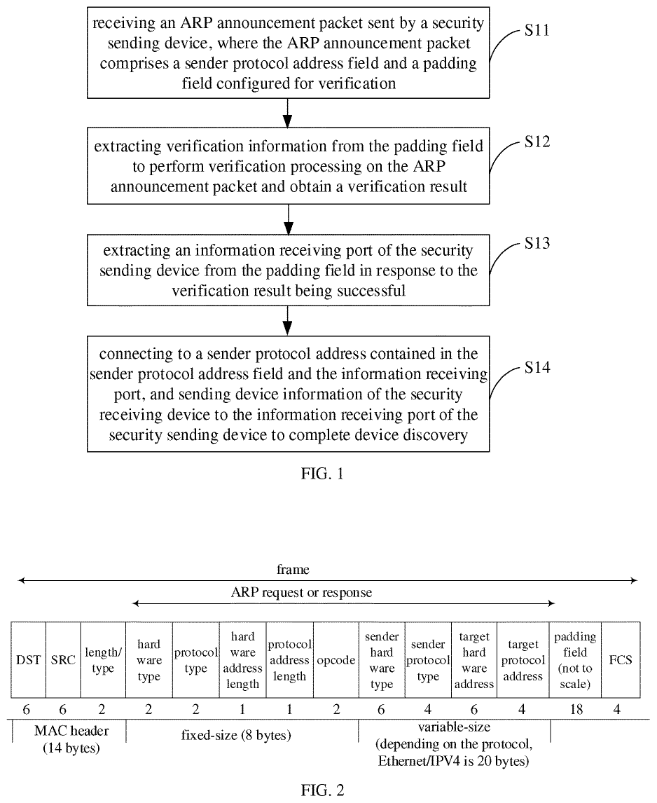

As shown in FIG. 1, FIG. 1 is a schematic flowchart of a device discovery method according to some embodiments of the present disclosure. It should be noted that the method of the present disclosure may not be limited to the process sequence shown in FIG. 1, if substantially identical results are achieved. The method may be applied to an electronic device with functions such as computing. For example, the electronic device may be an intelligent security device. The intelligent security device may include a security receiving device and a security sending device. The security receiving device may be a camera or a doorbell, and the security sending device may be a base station. It may be understood that in other embodiments, the security receiving device and the security sending device may be interchanged. That is, the security receiving device may be a base station, and the security sending device may be a camera, a doorbell, or the like.

In some embodiments, the device discovery method according to embodiments of the present disclosure may be implemented by a processor in an electronic device invoking computer program instructions stored in a memory. As shown in FIG. 1, the device discovery method applied to a security receiving device may include the following operations.

At operation S11, an ARP announcement packet sent by the security sending device is received, the ARP announcement packet includes a sender protocol address field and a padding field configured for verification.

The ARP announcement packet in a standard ARP protocol may be an ARP data packet, which may be configured to declare an IP address and a MAC address of a local device to a network. A node in the network may send an ARP announcement packet to share the IP address and MAC address of the node in the network with other nodes, so that all hosts in a LAN (VLAN) update their own ARP caches to map the IP address to the MAC address of the security sending device.

In some application scenarios, the devices involved in the device discovery may include a security sending device configured to send data and a security receiving device configured to receive data.

The security receiving device may receive the ARP announcement packet sent by the security sending device. The ARP announcement packet may include the sender protocol address field and the padding field for verification. It may be understood that the sender protocol address field may be a protocol address field of the security sending device. The security sending device may pad the sender protocol address field and the padding field for verification into the ARP announcement packet and send the ARP announcement packet to the security receiving device. In this way, the security receiving device may receive the ARP announcement packet sent by the security sending device.

In some embodiments, an Ethernet may specify that a minimum length of each frame may be 64 bytes. A total length of the ARP announcement packet may usually be 46-60 bytes. When the ARP announcement packet is combined with a 14-byte MAC header and a 4-byte FCS, the complete Ethernet frame can meet the minimum 64-byte frame length requirement specified by Ethernet protocol. Therefore, it may be ensured that a minimum length of an entire Ethernet frame (including an Ethernet header and a frame check sequence (FCS) checksum) may be 64 bytes.

FIG. 2 is a schematic structural diagram of an Ethernet frame according to some embodiments of the present disclosure. As shown in FIG. 2, main fields of the ARP announcement packet may occupy a total of 42 bytes, and FCS may occupy 4 bytes. After deducting 42 bytes of the main fields and 4 bytes of FCS, a length of the padding field may be set to 18 bytes (the random value may occupy 4 bytes, the CRC32 target verification value may occupy 4 bytes, the information receiving port of the security sending device may occupy 2 bytes, and the remaining 8 bytes may be reserved for byte alignment or future extension, without limitation in the present disclosure). The main fields occupying a total of 42 bytes may include a MAC header (14 bytes in total, where DST may occupy 6 bytes, SRC may occupy 6 bytes, and length/type may occupy 2 bytes), fixed-size fields (8 bytes in total, where the hardware type may occupy 2 bytes, the protocol type may occupy 2 bytes, the hardware address length may occupy 1 byte, the protocol address length may occupy 1 byte, and the opcode may occupy 2 bytes), and variable-size fields (20 bytes in total, where the sender hardware address may occupy 6 bytes, the sender protocol address may occupy 4 bytes, the target hardware address may occupy 6 bytes, and the target protocol address may occupy 4 bytes). That is, the main fields may include the hardware type, the protocol type, the hardware address length, the protocol address length, the opcode, the sender hardware address, the sender protocol address, the target hardware address, and the target protocol address. In some embodiments, the hardware type may occupy 2 bytes, and the field may indicate the hardware type used, such as Ethernet or wireless local area network. For the Ethernet, a value of the field may be 1. The protocol type may occupy 2 bytes, and the field may indicate a protocol type used, such as IPv4 or IPv6. For IPv4, a value of the field may be 0x0800. The hardware address length may occupy 1 byte, and the field may indicate a length of the hardware address. For an Ethernet MAC address, the value may be 6. The protocol address length may occupy 1 byte, and the field may indicate a length of a protocol address. For an IPv4 address, a value of the field may be 4. The opcode may occupy 2 bytes, and the field may indicate a type of the ARP announcement packet, such as request (1) or response (2). The sender hardware address may occupy 6 bytes, and the field may include a hardware address of a device sending the ARP announcement packet. The sender protocol address may occupy 4 bytes, and the field may include a protocol address of the device sending the ARP announcement packet. The target hardware address may occupy 6 bytes, and the field may include a hardware address of a target device. In an ARP request, the field may usually be set to 0 because the sender may not know the hardware address of the target. Target protocol address may occupy 4 bytes, and the field may include a protocol address of the target device.

At operation S12, verification information is extracted from the padding field to perform verification processing on the ARP announcement packet and obtain a verification result.

After receiving the ARP announcement packet, the security receiving device may extract the verification information from the padding field of the ARP announcement packet and perform the verification processing on the ARP announcement packet based on the verification information to obtain the verification result.

At operation S13, an information receiving port of the security sending device is extracted from the padding field in response to the verification result being successful.

It may be understood that the verification result may include success and failure. The information receiving port of the security sending device is extracted from the padding field in response to the verification result being successful. The corresponding ARP announcement packet may be discarded without processing in response to the verification result being unsuccessful.

At operation S14, the security receiving device is connected to a sender protocol address contained in the sender protocol address field and the information receiving port, and device information of the security receiving device is sent to the information receiving port of the security sending device to complete device discovery.

The security receiving device may be connected to the sender protocol address contained in the sender protocol address field and the information receiving port. For example, a TCP connection may be established to the sender protocol address and the information receiving port, and the device information of the security receiving device may be sent to the information receiving port of the security sending device to complete device discovery. The device information of the security receiving device may include an IP address of the security receiving device, anonymized device binding information, account association information, and any other suitable information, which is not specifically limited.

According to the above solutions, by receiving the ARP announcement packet sent by the security sending device, the ARP announcement packet includes the sender protocol address field and the padding field configured for verification; extracting the verification information from the padding field to perform the verification processing on the ARP announcement packet and obtain the verification result; extracting the information receiving port of the security sending device from the padding field in response to the verification result being successful; and connecting to the sender protocol address contained in the sender protocol address field and the information receiving port, and sending the device information of the security receiving device to the information receiving port of the security sending device, the device discovery may be completed. In the solutions of the present disclosure, the verification information may be stored in the padding field by the security sending device, thereby improving application extensibility. The information receiving port may be customized by the security sending device. Therefore, security problems caused by port occupation and being easily monitored may be reduced.

In some embodiments of the present disclosure, the extracting the verification information from the padding field to perform the verification processing on the ARP announcement packet and obtain the verification result, may include: extracting a random value and a target verification value from the padding field, and extracting the sender protocol address from the sender protocol address field; obtaining a verification value based on the sender protocol address, the random value, and a pre-shared salt value by using a preset algorithm; and comparing the verification value with the target verification value to obtain the verification result, the verification result is determined to be successful in response to the verification value being identical to the target verification value.

The security receiving device may extract the random value and the target verification value from the padding field and extract the sender protocol address from the sender protocol address field. The random value may be generated by the security sending device and padded into the padding field. For example, “/dev/random” of a Linux system, which may be used as a true random value generator, may be configured to generate an int (4 bytes) random value. Based on an entropy pool of the system, “/dev/random” may be very suitable for applications requiring high security, such as generation of an SSL key.

The verification value may be obtained based on the sender protocol address, the random value, and the pre-shared salt value by using the preset algorithm. In an encryption algorithm, a “salt value” may be an additional parameter configured to increase encryption complexity, and thereby reducing the possibility of an attacker cracking a password by using a pre-calculated method such as a rainbow table. In some embodiments, the pre-shared salt value may be preconfigured in both the security sending device and the security receiving device before device discovery. The pre-shared salt value may be stored in both the security sending device and the security receiving device, ensuring that the verification value calculated by the receiving device matches the target verification value generated by the sending device. The method of sharing the salt value is not limited in this disclosure, as long as both devices possess the identical salt value before performing the verification. The obtained verification value may be compared with the target verification value to obtain the verification result. In response to the verification value being identical to the target verification value, the verification result may be successful. In response to the verification value being different from the target verification value, the verification result may be unsuccessful.

In some embodiments of the present disclosure, the obtaining the verification value based on the sender protocol address, the random value, and the pre-shared salt value by using the preset algorithm, may include:

the verification value=CRC32(IP+Salt+Random value)

The CRC32 (Cyclic Redundancy Check) may represent the preset algorithm. The IP may represent the sender protocol address. The Salt may represent the pre-shared salt value. The Random value may represent the random value, “+” may denote concatenation of byte sequences.

It may be understood that a CRC32 value, that is, the verification value, may be calculated based on the sender protocol address, the pre-shared salt value, and the random value by using a CRC32 algorithm. The verification value may further be compared with the target verification value to obtain the verification result.

The random value may be a non-fixed value. The random value may be configured to increase randomness and uniqueness of the generated verification value and thereby reduce the risk of replay attacks.

In some embodiments of the present disclosure, the receiving an ARP announcement packet sent by a security sending device, may include: receiving the ARP announcement packet by using a first preset function.

Pseudocodes configured to send data and receive data in some embodiments of the present disclosure may be as follows:

```
#define ETHER_TYPE [symbol] x [symbol]
#define DEFAULT_IF “eth [symbol] ”
//...
// create a RAW socket
if ((sockfd = socket(AF_PACKET, SOCK_RAW, IPPROTO_RAW)) == −1) {
    perror(“socket”);
}
// send
if (sendto(sockfd, sendbuf, tx_len, [symbol] , (struct sockaddr*) [symbol] sa, sizeof(struct sockaddr_ [symbol] )) == −1) {
  perror(“sendto”);
  exit(1);
}
// receive
while(1) {
// receive a data packet
  int packet_len = recvfrom(raw_sock, buffer, MAX_BUF_SIZE, 0, [symbol] saddr, (socklen_t *) [symbol] saddr_len);
  if (packet_len [symbol] ) {
  perror(“Failed to receive packet”);
  exit(1);
  }
// print the received data packet
  printf(“Received packet; [symbol] s\n”, buffer);
  // check if the packet is an announce packet and perform authentication processing using the padding field
  //.....
} [symbol]
indicates data missing or illegible when filed
```

A RAW socket may be constructed. The security receiving device may receive the ARP announcement packet sent by the security sending device by using the first preset function. The first preset function may be a recvfrom function or any other suitable function, which is not limited.

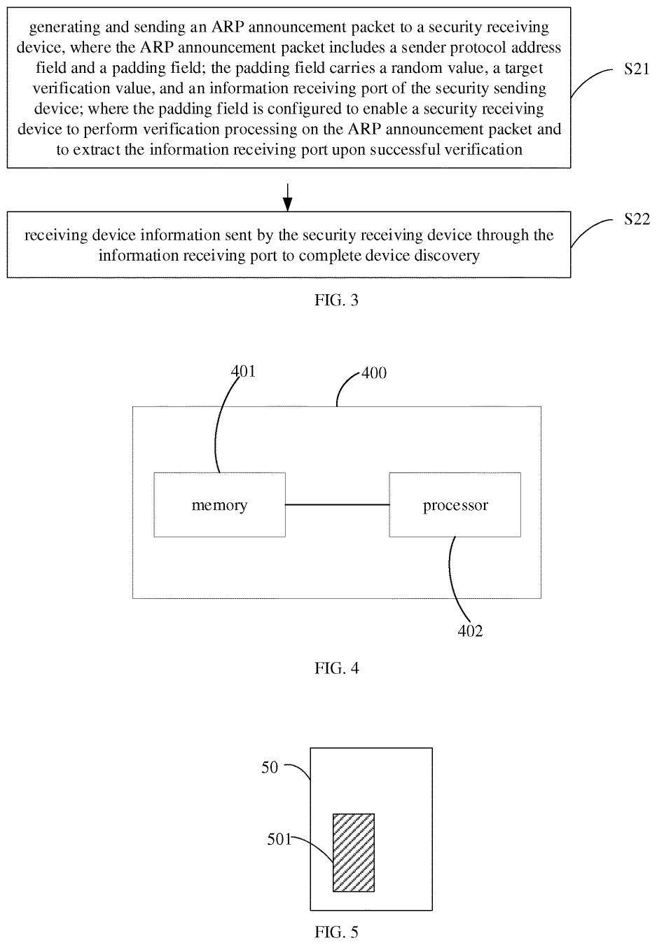

As shown in FIG. 3, FIG. 3 is another schematic flowchart of a device discovery method according to some embodiments of the present disclosure. It should be noted that the method of the present disclosure is not limited to the process sequence shown in FIG. 3, if substantially identical results are achieved. The method may be applied to an electronic device with functions such as computing. For example, the electronic device may be an intelligent security device. The intelligent security device may include a security receiving device and a security sending device. The security receiving device may be a camera or a doorbell, and the security sending device may be a base station. It may be understood that in other embodiments, the security receiving device and the security sending device may be interchanged. That is, the security receiving device may be a base station, and the security sending device may be a camera, a doorbell, or the like.

In some possible implementations, the device discovery method according to embodiments of the present disclosure may be implemented by a processor in an electronic device invoking computer program instructions stored in a memory. As shown in FIG. 3, the device discovery method applied to a security sending device includes the following operations.

At operation S21, the ARP announcement packet may be generated and sent to the security receiving device, the ARP announcement packet may include the sender protocol address field and the padding field configured for verification, the ARP announcement packet may be received by the security receiving device, the verification information may be extracted from the padding field to perform the verification processing on the ARP announcement packet and the verification result may be obtained, and the information receiving port of the security sending device may be extracted from the padding field in response to the verification result being successful.

The ARP announcement packet in the standard ARP protocol may be the ARP data packet, which may be configured to declare the IP address and the MAC address of the local device to the network. The node in the network may send the ARP announcement packet to share the IP address and the MAC address of the node in the network with other nodes, so that all hosts in a LAN (VLAN) update their own ARP caches to map the IP address to the MAC address of the security sending device.

In some application scenarios, the devices involved in the device discovery may include the security sending device configured to send data and the security receiving device configured to receive data.

The security receiving device may receive the ARP announcement packet sent by the security sending device. The ARP announcement packet may include the sender protocol address field and the padding field configured for verification. It may be understood that the sender protocol address field may be a protocol address field of the security sending device. The security sending device may pad the sender protocol address field and the padding field configured for verification into the ARP announcement packet and send the ARP announcement packet to the security receiving device. In this way, the security receiving device may receive the ARP announcement packet sent by the security sending device. After receiving the ARP announcement packet, the security receiving device may extract verification information from the padding field of the ARP announcement packet and perform the verification processing on the ARP announcement packet based on the verification information to obtain the verification result. The verification result may include success and failure. The security receiving device may extract the information receiving port of the security sending device from the padding field in response to the verification result being successful. The security receiving device may be connected to the sender protocol address contained in the sender protocol address field and the information receiving port. For example, the TCP connection may be established to the sender protocol address and the information receiving port.

At operation S22, the device information sent by the security receiving device may be received through the information receiving port to complete the device discovery.

The security receiving device may send the device information of the security receiving device to the information receiving port of the security sending device. The device information of the security receiving device may include an IP address of the security receiving device, the anonymized device binding information, the account association information, and any other suitable information, which is not specifically limited.

The security sending device may receive the device information sent by the security receiving device through the information receiving port to complete the device discovery.

In some embodiments of the present disclosure, the generating the ARP announcement packet, may include: obtaining the target verification value based on the sender protocol address in the sender protocol address field, the random value, and the pre-shared salt value by using a preset algorithm; padding the random value and the target verification value into the padding field configured for verification; and generating the ARP announcement packet based on the sender protocol address field and the padding field.

The target verification value may be obtained based on the sender protocol address in the sender protocol address field, the random value, and the pre-shared salt value by using the preset algorithm. For example, “/dev/random” of a Linux system, which may be used as the true random value generator, may be configured to generate the int (4 bytes) random value. Based on the entropy pool of the system, “/dev/random” may be very suitable for the applications requiring high security, such as the generation of the SSL key. A GUID generation algorithm may be used to generate a 32-byte fixed salt value, or any other achievable algorithm may be used, which is not specifically limited, to obtain the pre-shared salt value. Therefore, uniqueness, randomness, and sufficient length of the pre-shared salt value may be ensured to increase cracking difficulty.

The security sending device may pad the random value and the target verification value into the padding field configured for verification, so as to generate the ARP announcement packet based on the sender protocol address field and the padding field.

In some embodiments, padding of the ARP announcement packet of the present disclosure may be as follows:

| Ethernet frame header: | | | |
|---|---|---|---|
| Dest MAC: | ff:ff:ff:ff:ff:ff | | |
| Source MAC: | xx:xx:xx:xx:xx:xx | | |
| Eth type: | [symbol] | | |
| Ethernet data (ARP header): | | | |
| Hardware type: | | 1 | |
| Protocol type: | | [symbol] | |
| lladdr length: | | 6 | |
| IPv4 addr len: | | 4 | |
| Opcode : | | 1 | |
| Sender (MAC) address: | | | xx:xx:xx:xx:xx:xx |
| Sender IPv4 addr: | | | 192.168.3.16 |
| Target MAC: | | | [symbol] : [symbol] : [symbol] : [symbol] : [symbol] : [symbol] |
| Target IPv4 addr: | | | 192.168.3.16 |

[symbol]

indicates data missing or illegible when filed

The ARP announcement packet may include the hardware type, the protocol type, the opcode, the sender hardware address, the sender protocol address, the target hardware address, and the target protocol address. A value of hardware type may be 1, indicating that the hardware type may be Ethernet. A value of protocol type may be 0x0800, indicating that the protocol type may be IPv4. A value of the opcode may be 1, indicating that the opcode may be a request. A value of the sender hardware address may be xx.xx.xx.xx.xx.xx, indicating that the sender hardware address may be a MAC address of the security sending device. A value of the sender protocol address may be xxx.xxx.xxx.xxx, indicating that the sender protocol address may be an IP address of the security sending device. A value of target hardware address may be 00.00.00.00.00.00, indicating that the target hardware address may be all devices in a same broadcast network without a MAC address of a specific device. A value of the target protocol address may be xxx.xxx.xxx.xxx, indicating that the target protocol address may be no specific device, and the IP address of the security sending device may be padded to represent a broadcast ARP.

In some embodiments of the present disclosure, the obtaining the target verification value based on the sender protocol address in the sender protocol address field, the random value, and the pre-shared salt value by using the preset algorithm, may include:

the target verification value=CRC32(IP+Salt+Random value)

The CRC32 may represent the preset algorithm. The IP may represent the sender protocol address. The Salt may represent the pre-shared salt value. The Random value may represent the random value, “+” may denote concatenation of byte sequences.

It may be understood that the CRC32 value, that is, the target verification value, may be calculated based on the sender protocol address, the pre-shared salt value, and the random value by using the CRC32 algorithm. Further, the verification value obtained by the security receiving device based on the same sender protocol address, the same random value, and the same pre-shared salt value by using the same preset algorithm may be identical to the target verification value.

In some embodiments of the present disclosure, the device discovery method may further include: sending the ARP announcement packet by using a second preset function.

The pseudocodes configured to send data and receive data in some embodiments of the present disclosure may be as follows:

```
#define ETHER_TYPE [symbol] x [symbol]
#define DEFAULT_IF “eth [symbol]
//...
// create a RAW socket
if ((sockfd = socket(AF_PACKET, SOCK_RAW, IPPROTO_RAW)) == −1) {
    perror(“socket”);
}
// send
if (sendto(sockfd, sendbuf, tx_len, [symbol] , (struct sockaddr*) [symbol] sa, sizeof(struct sockaddr_ [symbol] )) == −1) {
  perror(“sendto”);
  exit(1);
}
// receive
while(1) {
// receive a data packet
  int packet_len = recvfrom(raw_sock, buffer, MAX_BUF_SIZE, [symbol] , [symbol] saddr, (socklen_t *) [symbol] saddr_len);
  if (packet_len [symbol] ) {
  perror(“Failed to receive packet”);
  exit(1);
  }
// print the received data packet
  printf(“Received packet; [symbol] s\n”, buffer);
  // check if the packet is an announce packet and perform authentication processing using the padding field
  //.....
} [symbol]
indicates data missing or illegible when filed
```

The RAW socket may be constructed. The Ethernet header may be then constructed. The security sending device may send the padded ARP announcement packet by using the second preset function. The second preset function may be a sendto function or any other suitable function, which is not specifically limited.

In some embodiments of the present disclosure, the device discovery method may further include: re-sending the ARP announcement packet a predetermined number of times at a first preset time interval, in response to no device information sent by the security receiving device being received within a preset time period; and sending the ARP announcement packet at a second preset time interval, in response to device information sent by the security receiving device being received within the preset time period.

After the security sending device sends the ARP announcement packet to the security receiving device, the security receiving device may perform the verification processing on the received ARP announcement packet. The security receiving device may send device information of the security receiving device to the security sending device in response to successful verification.

The security sending device may re-send the ARP announcement packet a predetermined number of times at a first preset time interval in response to no device information sent by the security receiving device being received within a preset time period. For example, the ARP announcement packet may be sent once every one second and repeatedly three times to reduce the risk of the devices being undiscovered caused by packet loss due to network factors.

The security sending device may send the ARP announcement packet at a second preset time interval in response to device information sent by the security receiving device being received within the preset time period. For example, the ARP announcement packet may be sent at an interval of 10 seconds to timely discover whether a new device joins the network or an original device goes offline.

The solutions of the present disclosure may efficiently discover related devices requiring communication, effectively reduce the quantity of network broadcast packets, and mutually discover devices to implement device interconnection in various complex network environments and three-address and four-address configuration schemes of a MESH routing environment.

Those skilled in the art may understand that a writing sequence of each operation in the foregoing methods in specific implementations may not mean a strict execution order and any limitation on an implementation process, and an execution order of each operation shall be determined according to functions and possible internal logics thereof.

As shown in FIG. 4, FIG. 4 is a schematic structural diagram of an electronic device according to some embodiments of the present disclosure. An electronic device 400 may include a memory 401 and a processor 402 coupled to each other. The processor 402 may be configured to execute program instructions stored in the memory 401 to implement operations in the foregoing device discovery method embodiments. In some implementation scenarios, the electronic device 400 may include, but is not limited to, a microcomputer and a server, which may not be limited herein.

In some embodiments the processor 402 may be configured to control itself and the memory 401 to implement operations in the foregoing device discovery method embodiments. The processor 402 may also be referred to as a Central Processing Unit (CPU). The processor 402 may be an integrated circuit chip with a signal processing capability. The processor 402 may also be a general-purpose processor, a Digital Signal Processor (DSP), an Application Specific Integrated Circuit (ASIC), a Field Programmable Gate Array (FPGA) or other programmable logic devices, discrete gate or transistor logic devices, or discrete hardware components. The general-purpose processor may be a microprocessor or any conventional processor. In addition, the processor 402 may be implemented by integrated circuit chips together.

As shown in FIG. 5, FIG. 5 is a schematic structural diagram of a non-volatile computer-readable storage medium according to some embodiments of the present disclosure. A computer-readable storage medium 500 may be configured to store program instructions 501. The program instructions 501, when executed by the processor 402, may be configured to implement operations in the foregoing device discovery method embodiments.

The foregoing descriptions of various embodiments tend to emphasize differences between various embodiments, and reference may be made to each other for the same or similar parts. For brevity, details are not described herein again.

In the several embodiments provided in the present disclosure, it should be understood that the disclosed method and related device may be implemented in other manners. For example, the foregoing described related device implementations are merely illustrative. For example, division into modules or units is only logical function division, and other division manners may be available in actual implementation. For example, units or components may be combined or integrated into another system, or some features may be omitted or not performed. In addition, coupling, direct coupling, or communication disconnection between each other shown or discussed may be indirect coupling or communication disconnection through some interfaces, devices, or units, and may be electrical, mechanical, or in other forms.

In addition, functional units in various embodiments of the present disclosure may be integrated into one processing unit, or each unit may exist alone physically, or two or more units may be integrated into one unit. The integrated unit may be implemented in a form of hardware or a form of a software functional unit.

In a case where the integrated unit is implemented in a form of a software functional unit and sold or used as an independent product, the integrated unit may be stored in a computer-readable storage medium. Based on such an understanding, the technical solutions of the present disclosure essentially, or a part contributing to the related art, or all or part of the technical solutions may be embodied in a form of a software product. The computer software product may be stored in a storage medium and includes several instructions for causing a computer device (which may be a personal computer, a server, a network device, or the like) or a processor to perform all or part of operations of the methods according to various implementations of the present disclosure. The foregoing storage medium may include: various media that may store program code such as a USB flash drive, a removable hard disk, a Read-Only Memory (ROM), a Random Access Memory (RAM), a magnetic disk, or an optical disc.

1. A device discovery method, applied to a security receiving device, comprising:
receiving an ARP announcement packet sent by a security sending device, wherein the ARP announcement packet comprises a sender protocol address field and a padding field configured for verification;
extracting verification information from the padding field to perform verification processing on the ARP announcement packet and obtain a verification result;
extracting an information receiving port of the security sending device from the padding field in response to the verification result being successful; and
connecting to a sender protocol address contained in the sender protocol address field and the information receiving port, and sending device information of the security receiving device to the information receiving port of the security sending device to complete device discovery.

2. The method as claimed in claim 1, wherein the extracting the verification information from the padding field to perform the verification processing on the ARP announcement packet and obtain the verification result, comprises:
extracting a random value and a target verification value from the padding field, and extracting the sender protocol address from the sender protocol address field;
obtaining a verification value based on the sender protocol address, the random value, and a pre-shared salt value by using a preset algorithm; and
comparing the verification value with the target verification value to obtain the verification result, wherein the verification result is determined to be successful in response to the verification value being identical to the target verification value.

3. The method as claimed in claim 2, wherein the obtaining the verification value based on the sender protocol address, the random value, and the pre-shared salt value by using the preset algorithm, comprises:
the verification value=CRC32(IP+Salt+Random value)
wherein the CRC32 represents the preset algorithm, the IP represents the sender protocol address, the Salt represents the pre-shared salt value, and the Random value represents the random value, “+” denotes concatenation of byte sequences.

4. The method as claimed in claim 1, wherein the receiving the ARP announcement packet sent by the security sending device, comprises:
receiving the ARP announcement packet by using a first preset function.

5. The method as claimed in claim 1, wherein the connecting to the sender protocol address contained in the sender protocol address field and the information receiving port, comprises:
establishing a TCP connection to the sender protocol address and the information receiving port.

6. A device discovery method, applied to a security sending device, comprising:
generating and sending an ARP announcement packet to a security receiving device, wherein the ARP announcement packet comprises a sender protocol address field and a padding field, the padding field carries a random value, a target verification value, and an information receiving port of the security sending device, wherein the padding field is configured to enable a security receiving device to perform verification processing on the ARP announcement packet and to extract the information receiving port upon successful verification; and
receiving device information sent by the security receiving device through the information receiving port to complete device discovery.

7. The method as claimed in claim 6, wherein the generating the ARP announcement packet, comprises:
obtaining the target verification value based on a sender protocol address in the sender protocol address field, the random value, and a pre-shared salt value by using a preset algorithm;
padding the random value and the target verification value into the padding field configured for verification; and
generating the ARP announcement packet based on the sender protocol address field and the padding field.

8. The method as claimed in claim 7, wherein the obtaining the target verification value based on the sender protocol address in the sender protocol address field, the random value, and the pre-shared salt value by using the preset algorithm, comprises:
the target verification value=CRC32(IP+Salt+Random value)
wherein the CRC32 represents the preset algorithm, the IP represents the sender protocol address, the Salt represents the pre-shared salt value, and the Random value represents the random value, “+” denotes concatenation of byte sequences.

9. The method as claimed in claim 6, further comprising:
sending the ARP announcement packet by using a second preset function.

10. The method as claimed in claim 6, further comprising:
re-sending the ARP announcement packet a predetermined number of times at a first preset time interval in response to no device information sent by the security receiving device being received within a preset time period.

11. The method as claimed in claim 6, further comprising:
sending the ARP announcement packet at a second preset time interval, in response to device information sent by the security receiving device being received within a preset time period.

12. The method as claimed in claim 6, further comprising:
re-sending the ARP announcement packet a predetermined number of times at a first preset time interval, in response to no device information sent by the security receiving device being received within a preset time period; and
sending the ARP announcement packet at a second preset time interval, in response to device information sent by the security receiving device being received within the preset time period.

13. The method as claimed in claim 6, wherein the padding field has a length of 18 bytes, wherein the random value occupies 4 bytes, the target verification value occupies 4 bytes, and the information receiving port occupies 2 bytes within the padding field.

14. A security sending device, comprising a memory and a processor coupled to each other, wherein the processor is configured to execute program instructions stored in the memory to implement:
generating and sending an ARP announcement packet to a security receiving device, wherein the ARP announcement packet comprises a sender protocol address field and a padding field; the padding field carries a random value, a target verification value, and an information receiving port of the security sending device, wherein the padding field is configured to enable a security receiving device to perform verification processing on the ARP announcement packet and to extract the information receiving port upon successful verification; and
receiving device information sent by the security receiving device through the information receiving port to complete device discovery.

15. The device as claimed in claim 14, wherein the generating the ARP announcement packet, comprises:
obtaining the target verification value based on a sender protocol address in the sender protocol address field, the random value, and a pre-shared salt value by using a preset algorithm;
padding the random value and the target verification value into the padding field configured for verification; and
generating the ARP announcement packet based on the sender protocol address field and the padding field.

16. The device as claimed in claim 15, wherein the obtaining the target verification value based on the sender protocol address in the sender protocol address field, the random value, and the pre-shared salt value by using the preset algorithm, comprises:
the target verification value=CRC32(IP+Salt+Random value)
wherein the CRC32 represents the preset algorithm, the IP represents the sender protocol address, the Salt represents the pre-shared salt value, and the Random value represents the random value, “+” denotes concatenation of byte sequences.

17. The device as claimed in claim 14, wherein the processor is further configured to implement:
sending the ARP announcement packet by using a second preset function.

18. The device as claimed in claim 14, wherein the processor is further configured to execute program instructions stored in the memory to implement:
re-sending the ARP announcement packet a predetermined number of times at a first preset time interval in response to no device information sent by the security receiving device being received within a preset time period.

19. The device as claimed in claim 14, wherein the processor is further configured to execute program instructions stored in the memory to implement:
sending the ARP announcement packet at a second preset time interval, in response to device information sent by the security receiving device being received within a preset time period.

20. The device as claimed in claim 14, wherein the processor is further configured to execute program instructions stored in the memory to implement:
re-sending the ARP announcement packet a predetermined number of times at a first preset time interval, in response to no device information sent by the security receiving device being received within a preset time period; and
sending the ARP announcement packet at a second preset time interval, in response to device information sent by the security receiving device being received within the preset time period.
